(19) United States
(12) Patent Application Publication
(10) Pub. No.: US 2008/0192650 A1
(43) Pub. Date: Aug. 14, 2008

(54) Method and Node for Locating a Network User

(76) Inventor: Johan Kolhi, Vaxholm (SE)

Correspondence Address: ERICSSON INC., 6300 LEGACY DRIVE, M/S EVR 1-C-11, PLANO, TX, 75024, US

(21) Appl. No.: 11/995,429

(22) PCT Filed: Jul. 14, 2005
(86) PCT No.: PCT/SE2005/001151

§ 371 Date: Feb. 28, 2008

(51) Int. Cl. H04L 12/28

(52) U.S. Cl. 370/254

(57) ABSTRACT

A method and network node for geographically locating an end node in a packet data communication network. The network node creates and stores information representing a path of data packets between first and second end nodes. At least one node address along the path is identified using the information. The network node then determines which address corresponds to an access node for the first end node and determines which access port of the access node the first end node is connected to. The access node address and port are then mapped against geographic data in a data bank to obtain information regarding the location of the first end node.

### FIELD OF THE INVENTION

The invention relates to a method and a network node for geographically locating an end node in a packet data communication network.

A problem with IP-based applications, such as Voice over IP (VoIP), is that it may be hard to locate an IP-client geographically. For traditional landline telephony this is a legal requirement in most countries, and possibly it will become a requirement for VoIP as well, but up to now no liable way of locating an IP-client geographically exists.

### BACKGROUND OF THE INVENTION

In conventional network environments, such as the Internet, a plurality of devices are connected through communication media. Such networks permit communicating devices (or users of devices) to easily exchange and share information among the various devices. Each device that forms an interface to a user may be referred to as an end node, in contrast to intermediate nodes, e.g. switches and routers that act as intermediary nodes, forwarding data from one point to another.

Networks may be configured and graphically depleted in a wide variety of common topologies. In other words, the particular configurations of network communication links (also referred to as paths) and nodes between a particular pair of nodes wishing to exchange information may be widely varied. Any particular connection between two computers attached to a network may be direct or may pass through a large number of intermediate nodes in the network. In addition, there may be a plurality of alternative paths through the network connecting any two network nodes. Data networks are therefore complex and vary in their configurations and topologies.

Certain network communication media and protocols are referred to as packet oriented. A protocol or communication medium may be said to be packet oriented in that information to be exchanged over the network is broken into discrete sized packets of information. A block of information to be transferred over the network is decomposed into one or more packets for purposes of transmission over the network. At the receiving end of the network transmission, the packets are re-assembled into the original block of data.

In general, each packet includes embedded control and addressing information that identifies both the source node which originated the transmission of the packet and the destination node to which the packet is transmitted. Identification of source and destination nodes is by means of an address associated with each node. An address is an identifier which is unique within the particular network to identify each node associated with the network. Such addresses may be unique to only a particular network environment (i.e., a network used to interconnect a single, self-contained network environment) or may be generated and assigned to nodes so as to be globally unique in co-operation with networking standards organizations.

In conventional network computing environments, a number of nodes are used in addition to interconnected networks to efficiently transfer data over the network. Routers and switches are network nodes that segregate information flows over various segments of a computer network. A segment, as used herein, is any subset of the data network including nodes and their respective interconnecting communication links. A single computer network communication link has a maximum data transfer bandwidth parameter defining the maximum rate of information exchange over that network. Where all nodes on a computer network share a common network medium, the maximum bandwidth of the computer network may be rapidly reached. The overall performance of the networked computing environment may thereby be reduced because information exchange requests may have to await completion of earlier information exchange requests presently utilizing the communication link.

A switch node is a node that filters out packets on the network destined for nodes outside a defined subset (segment) and forwards information directed between nodes on different segments of a network. The filtering and forwarding of such information is based on configuration information within the switch that describes the data packets to be filtered and forwarded in terms of source and/or destination address information (once address locations are “learned” by the switch(es)).

Network switch nodes and protocols associated therewith are also used to manage redundant paths between network nodes. Where there is only a single path connecting two network nodes, that single path, including all intermediate nodes between the source and destination nodes, represent a single point of failure in network communications between that source and destination node. Therefore, a plurality of redundant paths may be utilized. Multiple paths between two nodes enhances reliability of network communication between the nodes by allowing for a redundant (backup) network path to be used between two nodes when a primary path fails. On the other hand, redundancy costs, and normally operators choose to use network with “single-point-of-failure”, i.e. without backups.

As mentioned in the “field of the invention” a problem in IP-based applications, such as Voice over IP (VoIP), is that it may be hard to locate an IP-client geographically. Different ways of addressing this problem have been proposed. However, no liable way of locating an IP-client geographically exists. No proposed method is independent of the type of access network the user is connected to. So far only methods that are applicable in specific segments of a network have been proposed.

One proposed way of finding an end node is to use a “traceroute program”. Tracerouting has been elaborated in order to locate failures in the network by tracing the traveled path for a data packet in a network. Today, tracerouting is the most common way of tracing the route between two IP-nodes. Traceroute shows all intermediate IP-routers/hops between these IP-nodes and may give a basic network location of the IP-nodes, it may however not provide exact locations of end nodes.

In specifying a logical level for path tracing, the Open Systems Interconnection (“OSI”) network reference model is useful. The OSI reference model divides the tasks of moving information between the network devices into groups of manageable tasks. Each group of tasks is assigned to one of seven named and numbered logical layers of the OSI reference model.

Layer 3 (the Network layer) encompass routing and related functions that enable media to move across a network from a source node to a destination node. For example, Layer 3 may manage the routing of an IP packet from one Local Area Network (“LAN”) to another. Layer 2 (the Data Link layer) defines network and protocol characteristics, including physical addressing, network topology, sequencing of frames, and flow control.

Today, traceroute may only be performed at layer 3 such that only layer 3 nodes, e.g. routers or similar, show up on the tracing, whereas layer 2 nodes, e.g. switches or similar, are excluded from the tracing. This is a problem in large broadband networks, since most of the access networks contain layer 2 nodes, which followingly will not show up on the traceroute. Therefore, the location of a user/end node can only be traced up to the closest layer 3 node.

However, methods of tracing a path at layer 2 are being proposed and a new Ethernet standard (802.1ag) that is forecasted to be implemented in 2007 is currently being established. The standard is addressed to allow discovery and verification of the path, through bridges and LANs, and with the new 802.1ag standard it will be possible to trace layer 2 nodes. The standard specifies protocols, procedures, and managed objects to support transport fault management.

The 802.1ag standard will provide capabilities for detecting, verifying and isolating connectivity failures in all kinds of networks. It is however not aimed at locating users or end nodes.

Therefore, there still exists a need for a method of locating end nodes in a network.

### SUMMARY OF THE INVENTION

Thus, the object of the present invention is to provide a method and a network node for geographically locating an end node in a packet data communication network.

The object of the invention is achieved by the method of claim 1, a directly loadable computer program product according to claim 5, a stored computer program product according to claim 6, and a network node according to claim 7.

According to a first aspect of the invention a method of geographically locating an end node in a packet data communication network is provided. The method comprises the steps of creating and storing information representing a path of data packets between a first and a second end node in the network, whereby at least one node address along said path is identified using said information. Thereafter, a node address among the at least one node address that corresponds to the access node for the first end node is determined, whereby the access node has several access ports and whereby it is determined which port on the determined access node the first end node is connected to. Finally, the determined node address and the determined port are mapped against geographical data in a data bank, whereby information regarding the location of the first end node is obtained.

According to a second aspect, the invention relates to a computer program product directly loadable into a processing means in a packet data communication network, comprising the software code means for performing the steps relating to the method.

According to a third aspect, the invention relates to a computer program product stored on a computer usable medium, comprising readable program for causing a processing means in a packet data communication network, to control the execution of the steps relating to the method.

According to a fourth aspect, the invention relates to a network node adapted for geographically locating an end node in a packet data communication network is provided. The node comprises means for creating information representing a path of data packets between a first and a second end node in the network, and a database for storing said information. It also comprises means for identifying at least one node address along said path using said information, and means for determining one node address among the at least one node address that corresponds to the access node for the first end node, as well as means for determining which port on the determined access node the first end node is connected to. Further, the network node comprises means for mapping the determined node address and the determined port against geographical data in a data bank, means for obtaining, from said mapping, information concerning the location of the first end node, and means for displaying said information.

Thus, the invention makes it possible to geographically locate an end node in a packet data communication network.

An advantage of the invention is that it is independent of the type of access node the user is attached to. Whether the user is connected to the network via a telephone line, a cable TV router or fibre optics there will always exist a port that is unique to a specific end node location, and that port will always be traceable from the network.

The invention allows for a operator or any other authorized person to find out the physical location of an end user at any given moment. This is for instance useful when a subscriber makes a VoIP call to an alarm centre, e.g. 112 or 911, but gets disconnected or for some other reason is unable to state his location. With the method according to the invention the person can be instantly located and offered help.

Another advantage of the invention is that it provides the possibility trace hackers or other offenders performing illegal activities in a network.

Yet another advantage of the invention is that it provides the possibility to trace end nodes that are connected to nodes that are usually utilised as intermediate nodes.

The network node may easily be added to an existing customer data bank. Searches in the data bank in connection with the network node may be automated, something that could be an integrated function in e.g. an alarm centre.

### SHORT DESCRIPTION OF THE DRAWINGS

FIG. 1 shows a block diagram of the method according to the invention,

FIG. 2 shows an example network in which the network node according to the invention is implemented.

### DETAILED DESCRIPTION OF THE INVENTION

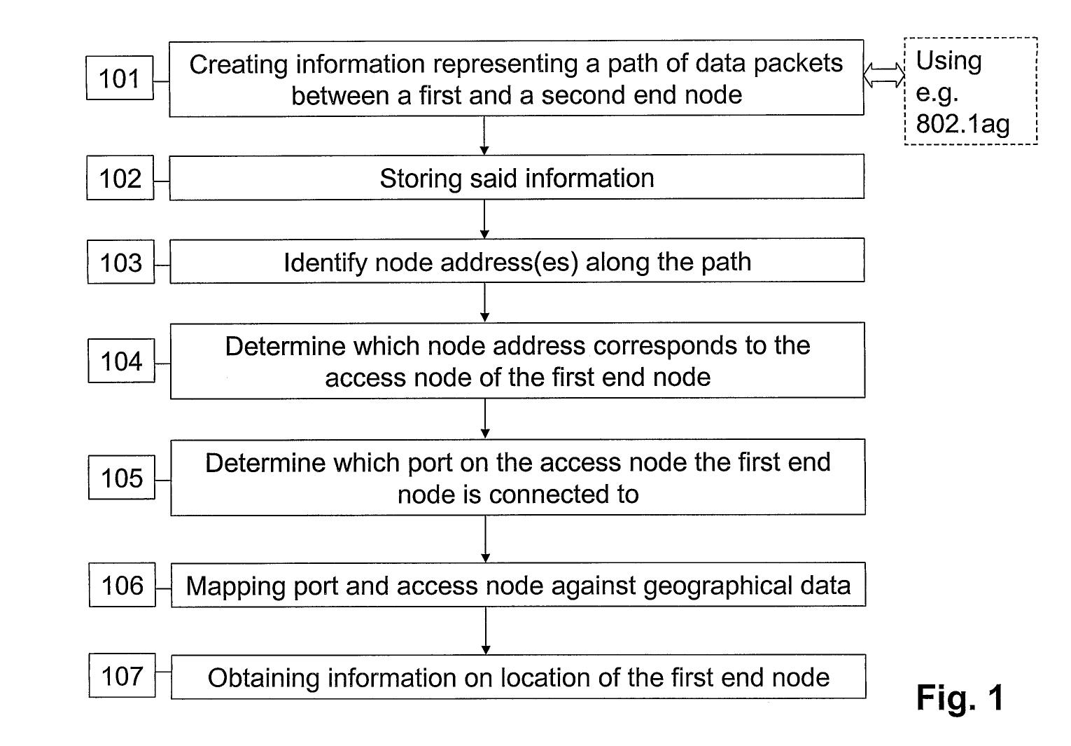

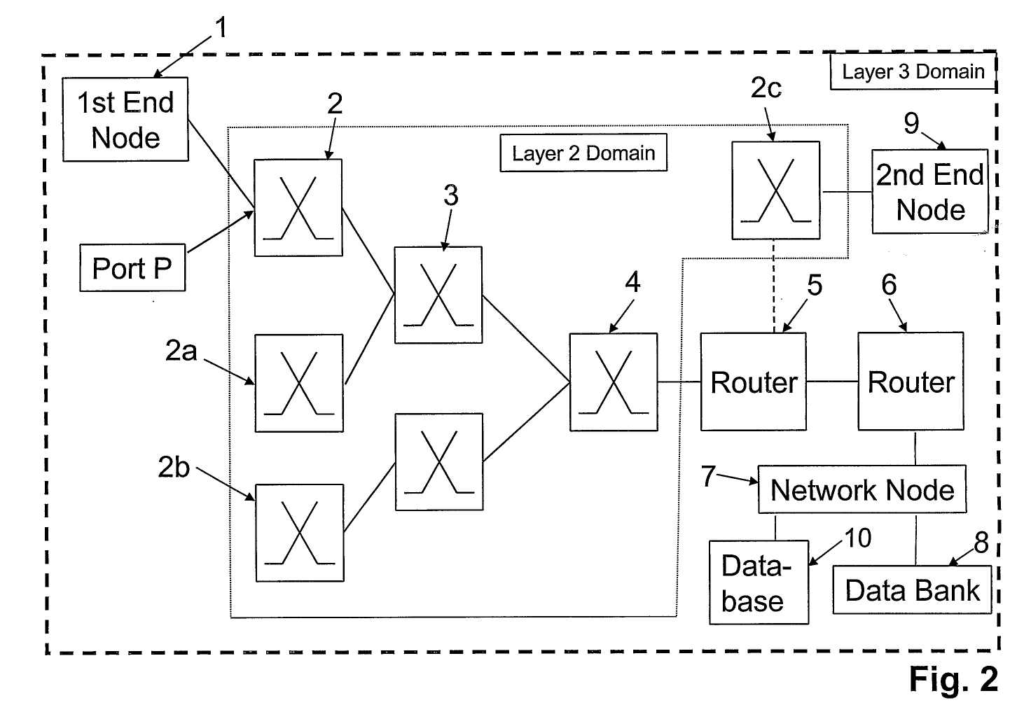

Now, with reference to FIGS. 1 and 2 the method according to the invention will be described. By using the method an end node 1 in a packet data communication network may be geographically located.

According to the invention this is done by first creating (step 101) information representing the path of data packets between the first end node 1 and a second end node 9 in the network, where the first end node 1 represents the queried node and the second end node 9 represents an arbitrary end node in the network, e.g. a public server, private PC or other, and only is schematically illustrated in FIG. 2. It is typically connected to the first end node via an access node 2c and a number of nodes that are not represented in FIG. 2. The additional nodes, implied by the dotted line connecting the access node 2c to the rest of the network, may be both layer 2 and layer 3 nodes.

The information regarding the path between the two nodes 1,9 is stored (step 102) in a database 10 and is later used for identifying (step 103) the address of at least one node address along the path. If several node addresses are identified it is necessary to determine (step 104) which of these node addresses that represents the access node 2 for the first end node 1. The access node 2 for the first end node 1 is the node in the network that is closest to the first end node 1. Once the access node 2 has been identified it is time to determine (step 105) which port P on the access node 2 that the first end node 1 is connected to.

The determined access node 2 and port P is then mapped (step 106) against geographical data in a data bank 8, and from this mapping information regarding the geographical location of the first end node is obtained (step 107).

According to a preferred embodiment of the invention the creating and storing of the path information is done in steps, see FIG. 2. The first step involves finding the penultimate Layer 3 hop, i.e. the last hop before the layer 2 segment. For this a traceroute program may be used. A traceroute is handled by a network node 7, which sends a packet of data to the destination end node 1. The packet includes a time limit value “time to live” that is selected so that it is exceeded by the first router 6 that receives the packet. The router 6 returns a Time Exceeded message, which allows for the network node 7 to store the address of the router 6 in a database 10. The traceroute program then increases the time and resends the packet so that it will reach the next router 5 on the path to the destination node 1. The procedure is repeated until the last router 5, which is a gateway to the layer 2 domain, has been reached.

Conventional traceroute is as mentioned above not possible at Layer 2. Therefore the only thing visible in a conventional traceroute beyond the gateway router 5 has been the IP-address of the end node 1. In an IP-network the IP-addresses are mobile and not fixed. They are supplied to a user in a random manner once he has been granted access to the network. The IP-address may or may not be the same as the IP-address supplied to the user during his previous session. Hence, IP-addresses are generally not tied to a specific geographical location and therefore it is not possible to locate the user geographically using only the IP-address. The only useful layer 3 information available to the network node 7 performing the traceroute is which gateway router 5 the end node is connected to. The gateway router 5 may however be shared with several thousands of other users, and therefore only provides a basic idea of in which area the end node is located.

Traceroute enhanced with the 802.1ag standard will however be capable of tracing the path even in the layer 2 domain. Hence, the remaining path may also be traced, step by step, starting with the switch 4 closest to the gateway router 5 end stepping via all intermediate switches 3 to the switch 2 that constitutes the access node for the end node 1. It will also be possible to trace which port P on the access node 2 the end node 1 is connected to.

Generally, the last part of the connection, e.g. a copper line, TV-cable optical fibre or any other type of fixed connection, runs from a access node 2, 2a, 2b, 2c in e.g. a basement of a residential building to a socket in a specific apartment. The switch and/or the socket may or may not be the same as the ones that are used for e.g. land line telephony or cable TV. In any case each port on the last switch corresponds to a socket at a specific location, such as an office, a house or an apartment. If the end node has a wireless connection to its access node it will be possible to locate the access node, which will reveal in what area or cell the end node is located. Other known methods will then have to be used to locate the wireless end node more closely.

Thus, a preferable way of arranging the data bank 8 is to store whereto each port on every access node leads, e.g. access nodes 2, 2a, 2b, 2c so that each port corresponds to a specific location, such as an office, a house or an apartment.

A general idea of the invention is to gather information of where to each of these port leads and set up a data bank based on this information. Once the data bank 8 is implemented geographical mapping of on-line users will be possible at all times. Mapping may also be possible for a certain time after the user has gone off-line as information created by the traceroute representing the path of data packets between two end nodes may be stored in the database 10 for as long as the operator decides.

According to another preferred embodiment of the invention the geographical information is implemented in an already existing data bank. For instance, operators have data banks with information regarding their subscribers. Normally, such data banks include information about the subscribers' home addresses and may therefore be updated to also include information regarding which port on which access node the subscribers' fixed connections are connected to, and whereto these connections lead.

For the method to work it is not mandatory to trace all intermediate nodes. To locate the user's end node geographically it is sufficient to know which access node 1 and which access port the end node is connected to. Normally, this is explored stepwise, as described above, but other ways may be used. When the tracing is done stepwise it is implicitly known which router and/or switch that is closest to the user, as these are the last to be traced. When other methods are used it is necessary to deduce which one is closest to the user.

According to a preferred embodiment of the invention the locations of all intermediary nodes, e.g. nodes 3-6, are also stored in the data bank 8. This will make it possible to plot a traceroute directly on a map. The storing of locations of intermediary nodes in the data bank 8 is also useful for tracing users that are connected to the network from locations inside a network, e.g. directly to a switch or a router, i.e. using an intermediary node as access node. Today it presents a weakness in networks that somebody with access to switches and routers, e.g. somebody that works for an operator, may get connected to the network without risking to be traced, since it presents an opportunity for inside or outside hackers to perform illegal activities on a network with a minimum risk of getting caught. Today, there is no way of tracing which switch an offender is connected to, or if the offender is connected to a router there is no way of knowing if he is connected directly to the router or via a number of switches. Either way, the traceroute would show up the same. Once the network node 7 according to the invention is implemented in a network it will be possible to trace the geographic location of such offenders by performing the method according to the present invention.

In order for the method according to the invention to work a network node 7 and an ancillary data bank 8 are implemented in the network. The network node may be implemented in an existing node, but may also be a new node. Further, the network node 7 may be implemented anywhere in the network. The network node 7 also comprises means for performing the steps relating to the method according to the invention. The data bank 8 may or may not be an integrated part of the network node 7.

The method of the present invention may preferably be implemented by a computer program product. Thus the present invention also relates to a computer program product directly loadable into a processing means in a data network, comprising the software code means for performing the steps of said method.

The present invention also relates to a computer program product stored on a computer usable medium, comprising readable program for causing a processing means in a data network, to control the execution of the steps of said method.

In the drawings and specification, there have been disclosed typical preferred embodiments of the invention and, although specific terms are employed, they are used in a generic and descriptive sense only and not for purposes of limitation, the scope of the invention being set forth in the following claims.

1-8. (canceled)

9. A method of geographically locating a first end node in a packet data communication network, the first end node having an access node in the network and the access node having a plurality of access ports, said method comprising the steps of:
creating and storing information representing a path of data packets between the first end node and a second end node;
determining a node address along the path that corresponds to the access node for the first end node, said node address including both layer 2 and layer 3 information;
determining an access port of the access node for the first end node, said step of determining an access port including determining both layer 2 and layer 3 information for the access port; and
mapping the determined node address and the determined access port to geographical data in a data bank thereby obtaining geographical information regarding the location of the first end node.

10. The method according claim 9 wherein the geographical information regarding the location of the first end node includes information regarding the location of a building containing a socket to which the first end node is connected.

11. The method according to claim 9, wherein the information regarding the location of the first end node includes information regarding a subscriber associated with the location of the first end node.

12. A computer program product directly loadable into a processor in a packet data communication network, said product causing the processor to:
create and store information representing a path of data packets between a first end node and a second end node;
determine a node address along the path that corresponds to an access node for the first end node, said node address including both layer 2 and layer 3 information;
determine an access port of the access node for the first end node, said step of determining an access port including determining both layer 2 and layer 3 information for the access port, and
map the determined node address and the determined access port to geographical data in a data bank to obtain geographical information regarding the location of the first end node.

13. A network node for geographically locating a first end node in a packet data communication network, the first end node having an access node in the network and the access node having a plurality of access ports, said network node comprising:
a database for storing information;
means for creating and storing in the database, information representing a path of data packets between the first end node and a second end node;
means for determining a node address along the path that corresponds to the access node for the first end node, said node address including both layer 2 and layer 3 information;
means for determining an access port of the access node for the first end node, said means for determining an access port including means for determining both layer 2 and layer 3 information for the access port; and
means for mapping the determined node address and the determined access port to geographical data in a data bank, thereby obtaining geographical information regarding the location of the first end node.

14. The network node according to claim 13, further comprising means for displaying the geographical information.

15. The network node according claim 13, wherein the data bank contains information regarding the location of a building containing a socket to which the first end node is connected.

16. The network node according to claim 13 wherein the data bank contains information regarding a subscriber associated with the location of the first end node.
